(19) United States
(12) Patent Application Publication
(10) Pub. No.: US 2011/0062123 A1
(43) Pub. Date: Mar. 17, 2011

(54) Micro-welding machine

(76) Inventor: Shitong Yang, Guangdong (CN)

(21) Appl. No.: 12/992,604

(22) PCT Filed: Mar. 3, 2009
(86) PCT No.: PCT/CN09/00221

§ 371 Date: Nov. 15, 2010

(30) Foreign Application Priority Data
May 16, 2008 (CN) PCT/CN2008/000952

(51) Int. Cl. B23K 11/00

(52) U.S. Cl. 219/78.01

(57) ABSTRACT

The present invention relates to a micro-welding technology and micro-welding machine which emerge for first time in resistance-welding field and mainly find their applications in the welding of tiny work pieces that can be processed only with the assistance of microscopic optical devices, such as the welding of leading pad of enameled wire during manufacture of kinds of electronic components having coils of small diameter. A micro-welding machine includes a main power supply, a welding head and a headstock. The main power supply includes a resistance welding transformer and a power supply controller; the main power supply outputs step-wave pulse through the power supply controller during welding process and, during welding process, the headstock connects an output portion of the resistance welding transformer to the welding head.

### FIELD OF THE INVENTION

The present invention relates to a micro-welding technology and micro-welding machine which emerge for first time in resistance-welding field and mainly find their applications in the welding of tiny workpieces that can be processed only with the assistance of microscopic optical devices, such as the welding of leading pad of enameled wire during manufacture of kinds of electronic components having coils of small diameter.

### BACKGROUND

It is a new technique to directly weld enameled wire. Regarding this new technique, the applicant has filed many patent applications including “a spot welding machine capable of directly welding enameled wire” (Chinese Patent Application CN01114785.7), “a spot welding head used for spot welding machine” (Chinese Patent Application CN 01114808.X), “prestressed electrode for a spot welding machine” (Chinese Patent Application 93245377.5), “welding head for a resistance welding machine and the method for forming the same” (Chinese Patent Application CN2005121259.2), “headstock of a spot welding machine capable of indicating pressure” (Chinese Patent Application CN01114856.X), “welding head clip for a spot welding machine” (Chinese Patent Application CN01114831.4), “welding head clip with a light source” (Chinese Patent Application CN01242320.3), “monitoring device for monitoring working condition of a welding head of a spot welding machine capable of welding enameled wire directly” (Chinese (Chinese Patent Application CN200410015223.1) and the like. All these patent applications demonstrate that technique of enameled wire direct-welding has developed to full extent.

Prior art welding machine suffers from short lifespan resulted from its welding head. For example, some welding machines can only provide several hundred welding points. Short lifespan of welding head results in negative effect on development of direct-welding of enameled wire. It is because in a conventional welding machine, only square wave pulse having constant amplitude is output, regardless of diameter of the wire. This kind of design is formed because no one before has recognized in micro-world, relationship maintains among many parameters such as thickness, material, duration of burning, diameter of the wire of the insulating varnish, welding current of the wire conductor and duration of welding of the wire conductor. Especially, it is critical to carefully regulate the pulse to be output to meet certain welding requirement, when a workpiece with a diameter of 0.1 mm is welding. This is also what the invention will solve.

### SUMMARY OF THE INVENTION

At first, the present invention will be directed to an introduction to concepts of micro-welding and micro-welding machine with the purpose of making more people understand the techniques of enameled wire direct-welding and tiny workpiece welding.

The concept of micro-welding is illustrated as follows. It means welding of tiny workpiece by resistance welding technique. A micro-welding machine necessarily includes two parts, namely, microscopic optical construction and resistance welding machine for performing micro-welding. As the workpiece is very tiny, and a certain working distance should be maintained during welding process, operator can't clearly catch sight of the workpiece joint, or can't keep his sight of the joint for a long time. As such, welding process must be performed with the assistance of optical enlargement device such as microscope. The second part-resistance welding machine is also referred to as construction of the micro-welding machine. As the workpiece to be welded is very small, adjustment must be made to many parameters such as type of power supply, power magnitude of the power supply, construction of the electrodes and electrode clip, other welding parameters and welding force. Particularly, adjustment must be done to pulses output such that the output pulses will be more accurate. For example, the output pulses may be regulated by square wave having voltage of 0.01 v and duration of 1 ms. It is not enough, and it should also be further regulated to step-wave pulses to meet the requirement of micro-welding. In other words, requirements must be met for resistance spot welding machine.

One object of the invention is to provide a micro-welding machine used in resistance welding field. This kind of welding machine can output more accurate pulse during welding of tiny workpiece and direct-welding of enameled wire, thereby extending the lifespan of the welding head used for directly welding the enameled wire, and improving welding quality of the tiny workpiece.

To obtain the above object and under the novel concept of the invention, the invention provides a micro-welding machine which includes a main power supply, a welding head and a headstock. The main power supply includes a resistance welding transformer and a power supply controller. The main power supply outputs step-wave pulse through the power supply controller during welding process. During welding process, the headstock will connect an output portion of the resistance welding transformer to the welding head.

The power supply controller includes a control circuit for generating pulse output, at least a function key for providing signal to the control circuit so as to regulate the pulse output, and a display device electronically connected with the control circuit so as to output information.

The step wave generated by the power supply controller is formed by ∠θ₁, ∠θ₂, a first step (V₁, T₁), and a second step (V₂, T₂). The pulse output rises to the first step V₁ at an angle ∠θ₁ and is maintained for a time of T₁. Afterwards, the pulse output rises further to the second step V₂ and is maintained for a time of T₂. Then, the pulse output falls at an angle of T₂ until the end of the pulse output. The above parameters constituting the step wave such as V₁, T, V₂ and T₂ may be adjusted, while the parameters such as ∠θ₁ and ∠θ₂ may be designed as adjustable or unadjustable.

The power supply controller has at least a function key for regulating voltage of the first step.

The power supply controller has at least a function key for regulating voltage of the second step.

The power supply controller has at least a function key for regulating duration of the first step.

The power supply controller has at least a function key for regulating duration of the second step.

The power supply controller has at least a function key for regulating rising angle ∠θ₁ of the pulse output.

The power supply controller has at least a function key for regulating falling angle ∠θ₂ of the pulse output.

The welding machine is of a capacitor energy storage type or an invertible power type.

The headstock is a headstock of the spot welding machine and capable of indicating pressure.

The welding head is a spot welding head, a resistance welding head or a pair of parallel electrodes, or a pair of upper and lower electrodes.

The step-wave pulse output provided by the control circuit of the power supply controller may be generated through a digital circuit such as ADC, or by charging a capacitor with a current-constant source and then switching the potentials.

Compared with prior art, the inventive micro-welding machine features its main power supply which provides for step-wave pulse output by the power supply controller so as to weld an enameled wire, thereby reducing risk of damage caused to the welding head by excessive current during process of burning off the insulating varnish of the enameled wire, and hence prolonging the life of the welding head. Moreover, the welding quality of the tiny workpiece is also improved.

Other advantages and novel features will be drawn from the following detailed description of embodiments with attached drawings, in which:

### BRIEF DESCRIPTION OF THE DRAWINGS

FIG. 1 shows a coordinate system in which a step wave defined by the width and amplitude of a pulse and output by the micro-welding machine of the invention is illustrated;

FIG. 2 is a schematic circuit diagram of the welding machine of the invention and shows the location of node A;

FIG. 3 shows a diagram of a digital circuit DAC for achieving the step wave of FIG. 1;

FIG. 4 shows a circuit diagram which realizes the step wave of FIG. 1 by charging a capacitor with current-constant source and by switching potentials;

FIG. 5 shows a schematic wave form output by a digital-analog converter DAC0 of a single chip with model of C8051F020 used in the circuit of FIG. 4;

FIG. 6 is a diagram in which the relationship between parameters θ and T of expression (2) is presented;

FIG. 7 shows the relationship between parameters u_{c(t)} and t according to one embodiment in which ramp wave is generated by charging the capacitors with current-constant source.

### DETAILED DESCRIPTION

Now, description will be made to various embodiment of the micro-welding machine of the invention in conjunction with the accompanying drawings.

To directly make the enameled wire welded, one of the following welding heads normally will be used prestressed electrode for a spot welding machine as disclosed in Chinese Patent Application No. 93245377.5, spot welding machine as disclosed in Chinese Patent Application No. 01114808.X, or welding head as disclosed in Chinese Patent Application No. 2005121259.2 (relating to a resistance welding head and method of making the same). By analyzing configuration of these welding heads, it can be found that each welding head has its two electrode tip portions pressed against each other, or ohmic contact with each other, or the both tip portions are integrally formed.

The inventor of the application has drawn a conclusion after a large number of experiments, research and analysis. The principles underlining the directly welding of the enameled wire can be summarized as follows. When starting welding, current flows. As the enameled wire is coated with an insulative layer, the current will all come across the tip portions of the two electrodes of the welding head, and thus electric sparks will be generated on the tip portions of the welding head. These electric sparks cause the insulating varnish coated on the welding head burned and then peeled off such that the metal portion is exposed. It is known that the electrical conductivity of both the copper core and metal substrate inside the enameled wire is larger than that of the electrode material. Therefore, when subject to the welding force and heat generated by the resistance, the contact resistance between the workpiece and welding head is smaller than that formed between the two electrode tip portions. In this case, large amount of current flows into the workpiece, thereby realizing of the resistance welding in the same pulse output, and the current passing through the two electrode tip portions becomes bias current.

Normally, it will only take several milliseconds to tens of milliseconds to complete the whole direct welding process of the enameled wire in consideration of the diameter of the wire.

For a spot welding machine capable of directly welding the enameled wire (as disclosed in Chinese Patent Application No. 01114785.7) or a conventional precise welding machine, it only requires that the current and voltage output by the welding machine be stable. In this case, the wave form of the pulse output is generally square wave or other similar wave. However, according to the principle of directly welding the enameled wire discussed above, before removal of the insulating varnish from the enameled wire, large amount of current will firstly concentrates on the two electrode tip portions which are pressed against each other or formed integrally, thus resulting in electrical sparks on the tip portions. With the welding process going on, electrical sparks are generated on the tip portions frequently, and this will have bad effect on the construction of the electrode tip portions. When there is no spark generated any more on the tip portions, it will be difficult to burn off the insulating varnish and consequently, welding process will be difficult to proceed. As a result, prior art welding machines suffer from the very short lifespan of welding head. For example, some welding machines only have a lifespan of hundreds of welding points. This largely suppresses the promotion and application of the technique of directly welding the enameled wire.

The whole process of directly welding the enameled wire can be divided into two periods, one for removal of the insulating varnish and the other for welding, though the time taken to directly welding the enameled wire is very short (for example, several milliseconds to tens of milliseconds). As such, several questions come out. The current required for the period of burning off the varnish is equal to that required for the period of welding? Is it reasonable to output pulses of square wave form? How to provide current accurately for welding directly the enameled wire?

To answer the above questions, the entire process of directly welding the enameled wire is recorded by a high speed camera with the frequency of 10,000 frames/second. The actual wave form of the current and voltage present during the welding process is measured by a resistance welding machine-dedicated analyzer. In addition, the dynamic resistance during the whole welding process is also monitored. By way of the above high technologies and through scientific analysis, the above principle of welding directly the enameled wire is concluded. Moreover, the following results are also obtained.

The current required for burning off the insulating varnish remained on the enameled wire may be smaller than that used for the welding, though the diameter of the wire to be welded may vary. The current for burning off the insulating varnish is only 65%-85% of the current for the welding. In other words, it should be ensured that electrical sparks will be generated on the two electrode tip portions so as to burn off the varnish. Meanwhile, it should also be avoided that large electrical sparks will be formed on the two tip portions due to overlarge current output, since the large current will cause detriment to the tip portions of the welding head during process of burning off the varnish. It is surprisingly shown by photos taken by the high speed camera that no electrical spark is generated on the two electrode tip portions during the welding period, indicating that the current is directed into the work-piece, while the current flowing across the two tip portions becomes the bias current.

The pulse duration needed for burning off the insulating varnish is substantially equal to that needed for the welding process.

Based on above results, the welding machine of the invention includes a main power supply, a welding head and a headstock. The main power supply, which constitutes the major part of the welding machine, includes a resistance welding transformer and a power supply controller. An input cable and output cable are provided on the resistance welding transformer. The power supply controller adjusts the output of the resistance welding transformer. It is well known in the resistance welding field that a welding machine is generally referred to as a main power supply, while the welding head and headstock are regarded as the accessory devices of the machine. To make the work-piece welded, the welding head (also known as electrode) should be connected to the output end of the transformer. The headstock realizes the connection and provides welding force. The welding head used in the present invention may be selected from a spot welding head (as disclosed by Chinese Patent Application No. 01114808.x) or resistance welding head (as disclosed by Chinese Patent Application. No 2005121259.2). Alternatively, a pair of parallel electrodes or an upper electrode combined with a lower electrode may be used as the welding head of the invention in case that the work-piece is other than the enameled wire. Moreover, a headstock of spot welding machine (such as that disclosed in Chinese Patent Application No. 01114856.x) may be used as the headstock of the invention.

The main power supply of the welding machine is the major part of the invention. The main power supply may be implemented by a capacitor energy type of welding machine of which the power factor is high, the response speed is fast, heat is sufficient and welding time is short. An invertible power welding machine may also be selected as the main power supply of the invention.

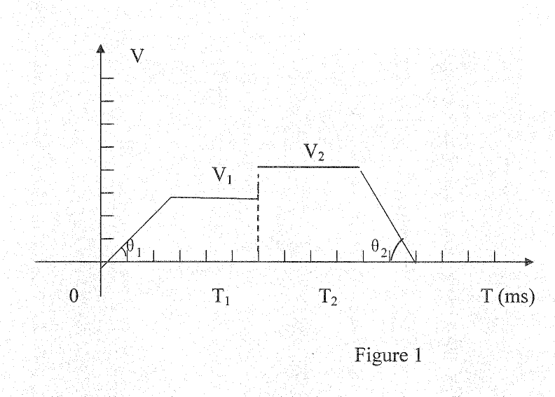

Take the welding machine disclosed in Chinese Patent Application No. 01114785.7 as an example. The welding machine is a capacitor energy storage type of welding machine under control of the constant voltage. The machine outputs the pulse of square wave having voltage of 0.01 V and duration of 1 millisecond. In addition, the output current of the machine is regulated by adjustment of the pulse. Research has shown that this type of welding machine is still far away from meeting the requirement of welding enameled wires. In the present invention, the power supply controller subdivides pulse of square wave into two portions, one of which is preceding portion of the pulse output, while the other is posterior portion of the pulse output. The two portions of the pulse output define a step shape due to amplitude difference of the two portions. As a result, it is called step wave pulse. The preceding portion of the pulse output is called a first step, while the posterior portion is called a second step. As shown in FIG. 1, the step wave pulse includes a pulse rising angle ∠θ₁, a first step V₁, T₁, a second step V₂, T₂ and pulse falling angle ∠θ₂. When pulse output is started, the pulse voltage rises at the angle ∠θ₁. This angle of ∠θ₁ is adjustable or may be set to certain value initially and then be fixed to that value. The pulse voltage rises to a height and is maintained at this height. The height and time during which the height is maintained define the first step V₁, T₁ both of the parameters being adjustable. The first step provides desired current to burn off the insulating varnish. Then, the pulse voltage rises further to a predefined height of voltage and is maintained at this height a period of time. This period of time is called the second step V₂, T₂ both of the parameters being also adjustable. The second step provides desired current to welding process. Finally, the pulse voltage falls at the angle ∠θ₂ to the end. The angle of ∠θ₁ serves to suppress the impact of transient large current on the welding head and work-piece during output of the pulse. The angle of ∠θ₂ functions to maintain heating process. As the angles ∠θ₁ and ∠θ₂ may vary and therefore, when the two angles are defined, the duration of voltage rising or falling is also defined. Accordingly, when defining the duration of the pulse, no additional time for voltage rising or falling is required.

Specifically, the power supply controller includes a control circuit for providing pulse output, at least one function key for supplying signal to the control circuit in order to regulate the pulse output, and a display device electronically connected with the control circuit for outputting information.

According to the micro-welding machine of the invention, the pulse output is divided into a first step V₁, T₁ and a second step V₂, T₂ which cooperatively define a step wave. The parameters such as V₁, T₁, V₂ and T₁ are designed to be adjustable, as the diameter, insulating material or thickness of the insulating varnish of enameled wire may vary. Similarly, the parameters such as angles ∠θ₁ and ∠θ₂ may also be configured as adjustable, or preset to a fixed value.

As the square wave output of the spot welding machine of the invention is regulated at level of 0.01 v and 1 ms, and the pulse is further designed to be a step wave of which the parameters of ∠θ₁, ∠θ₂, V₁, T₁, V₂ and T₂ can be regulated, the output current is more precisely controlled. As generally the power supply outputting the step wave applies to situations where welding of tiny work-piece must be done with the assistance of microscopic optical devices, the main power supply of the invention is referred as to a micro-welding machine so as to distinguish it from conventional precise welding machine.

The forming process of the inventive step wave will be described below with reference to various embodiments of the invention.

Take a welding machine of capacitor energy storage type as an example in which the current output is controlled by regulating the amplitude (voltage) of the pulse output. FIG. 1 shows a coordinate system where the amplitude and width of the pulse output define together a step wave. In the figure, the ordinate V represents amplitude of the pulse output (namely, voltage with unit of V), while the abscissa T represents the width thereof (namely, time with unit of ms). The step wave is defined by a pulse rising angle ∠θ₁, a first step V₁, T₁, a second step V₂,T₂, and a pulse falling angle ∠θ₂. When pulse output is started, the pulse amplitude V rises at the angle ∠θ₁. The pulse amplitude V rises to a certain value and is maintained at this value for a period of time T₁. The period defines the first step V₁, T₁. Afterwards, the amplitude of the pulse output jumps to a new value of V₂ and is maintained at this amplitude for a period of time T₂. This second period defines a second step V₂, T₂. Next, the pulse output falls at the angle ∠θ₂ to the end. As shown in FIG. 1, ∠θ₁ is 50°, V₁ is 0.75 v, T₁ is 4 ms, V₂ is 1.00 v, T₂ is 4 ms, and ∠θ₂ is 75°.

As the angles ∠θ₁ and ∠θ₂ may vary and therefore, when the two angles are defined, the duration of voltage rising or falling is also defined. Accordingly, when defining the duration of the pulse, no additional time for voltage rising or falling is required.

The step wave is defined by one pulse output. The first step serves to get rid of the insulating varnish by burning the enameled wire, whereas the second step serves to perform welding process. This step wave is different from prior art concept of dividing the entire welding process into several wave forms such as preheat pulse, welding pulse and maintaining pulse as described in some publications. It is because these individual pulses are output separately. A gap exists between the preheating pulse and welding pulse, or exists between the welding pulse and maintaining pulse. Comparatively, according to the invention, the first and second steps are continuous and no gap of time exists between the two steps. There exists only voltage jump.

Due to the step wave of the invention, the micro-welding machine finds its application not only in welding of enameled wires, but also in precise welding of other tiny work-piece such as repair of printed circuit board, connection of solar cells, welding of various equipments used in fields for example hospital, national defense and Aeronautics and Astronautics. For the invention, preheating occurs in the first step of the step wave, while heat conservation happens in a period during which the pulse falls at the falling angle. As a result, sputtering is reduced and welding quality is improved, as compared to conventional welding machine in which gap exists between preheating pulse and welding pulse or between welding pulse and maintaining pulse. The work-piece is very small and therefore, heat will be dissipated rapidly during intermittent period. In addition, discharge time of a capacitor energy storage type welding machine is short, and the transient current is high, thus resulting in damage to the work-piece. The pulse rising angle of the step wave of the invention can effectively suppress impact of the transient heavy current on the work-piece, reducing cohesion of the electrode with the work-piece, and making the electrode life extended. Of course, a pair of parallel electrodes or the combination of an upper electrode and a lower electrode may be utilized in case that tiny work-piece other than enameled wires is to be welded.

The description will now be made to formation of the step wave with reference to the welding machine circuit as disclosed in Chinese Patent Application No. 01114785.7

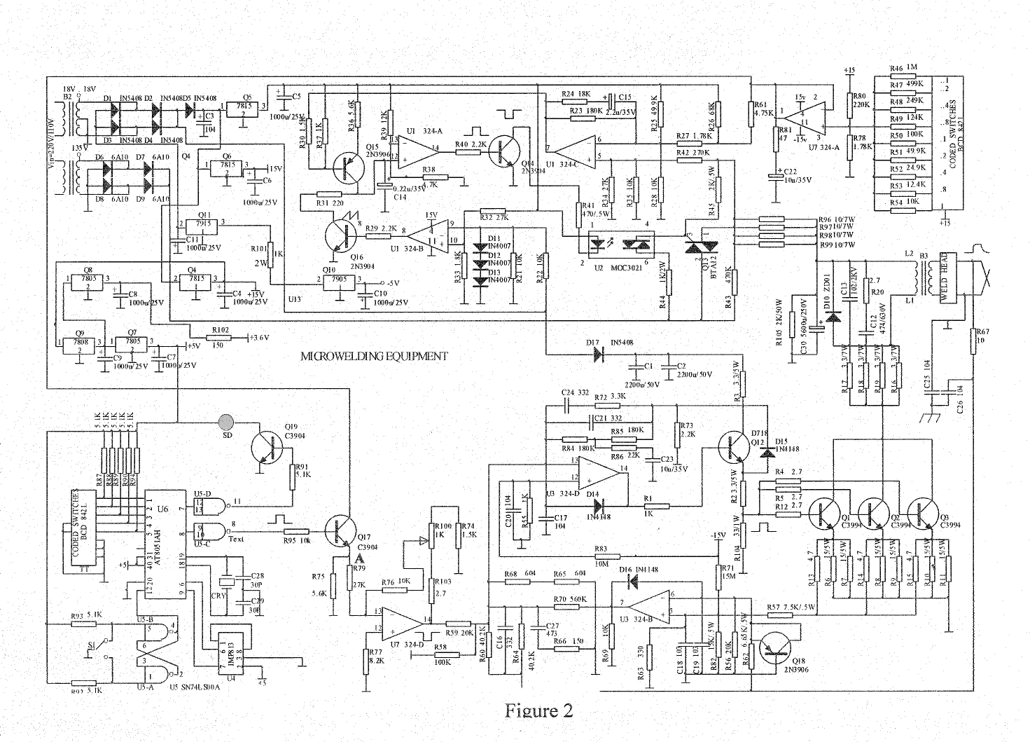

FIG. 2 shows a schematic circuit diagram of the welding machine disclosed in Chinese Patent Application No. 01114785.7. As shown in FIG. 2, voltage with arbitrary wave form and suitable amplitude may be applied at node A, then the voltage wave form is processed by a amplifier circuit and feedback circuit, and finally a voltage wave form having amplitude proportional to that of and the same shape with the originally applied voltage wave form is obtained at the output end of the pulse transformer.

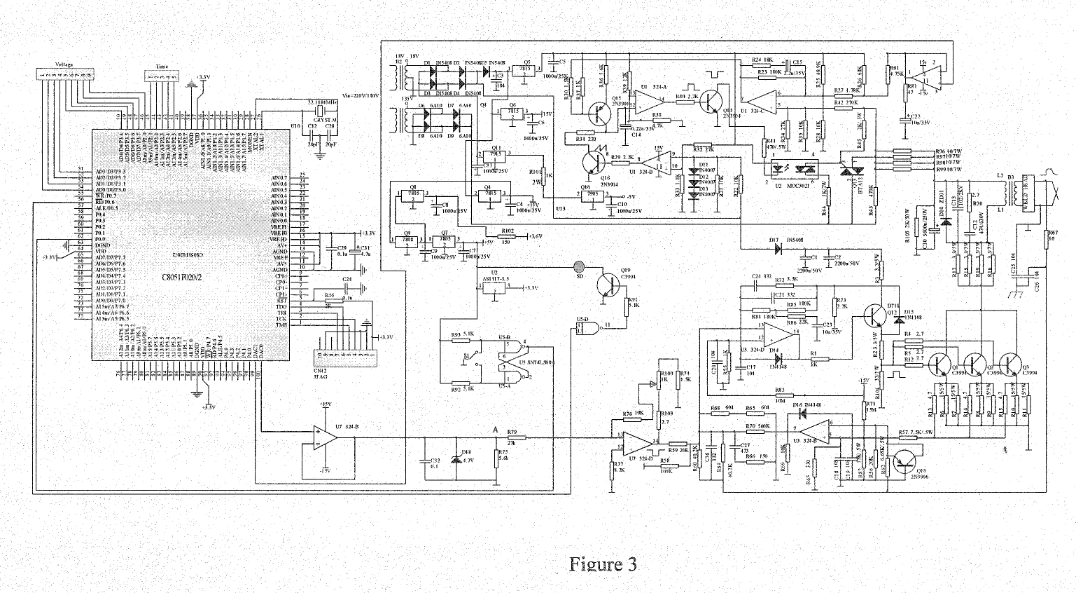

Accordingly, to output the voltage wave form shown in FIG. 1 by the welding machine, voltage wave form with the amplitude proportional to that of and the same shape as the wave form of FIG. 1 should be applied to node A. Many methods may be used to generate the wave form of FIG. 1. For example, analog circuit or digital circuit may be implemented as the control circuit of the power supply control device. Optionally, a combination of the analog circuit and digital circuit may be employed as the control circuit of the power supply control device. FIG. 3 shows a diagram in which a digital circuit DAC is utilized to obtain the step wave of FIG. 1 at the output of the welding machine. FIG. 4 shows a diagram in which the step wave of FIG. 1 is realized by charging capacitors with current-constant source and by switching potential.

Operation of the above two circuits will be discussed as follows.

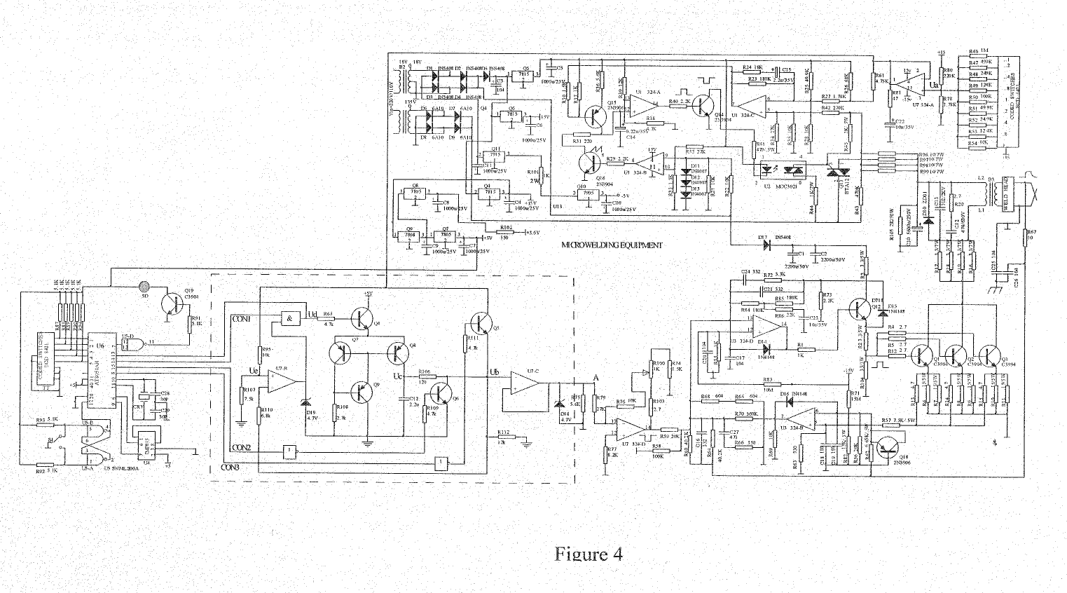

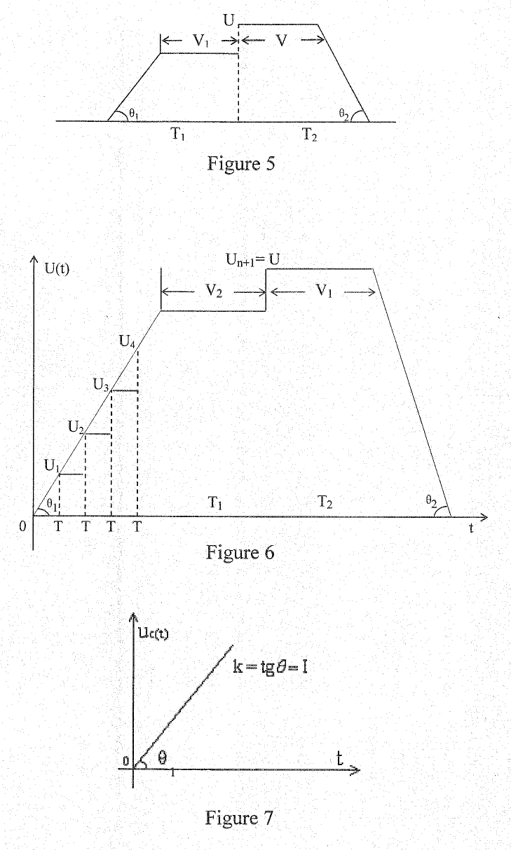

Shown in FIG. 3 is a single chip with model “C8051F020” which is an integrated mixed system on chip (SOC) with the operation speed of 25 MPIS and has plural functional modules. The single chip has two 12-bit digital to analog converters DAC0 and DAC1 with the conversion speed of 1 MHz, thus sufficiently meeting requirement of the welding machine of the invention, finishing the control of the entire welding machine and outputting precise and smooth voltage wave form. In the circuit diagram of FIG. 3, DAC0 is used for outputting the wave form of FIG. 5. The shape of the wave form of FIG. 5 is defined by procedure calculation. The wave form signal is initially processed by a voltage follower (U7324-B), then filtered smoothly by a capacitor C32, and finally is imposed on node A. DAC1 outputs voltage Ua and imposes it to a charging circuit according to the input and predefined voltage. Consequently, the voltage of an energy storage capacitor C30 is regulated to ensure that it has sufficient energy to output, hence generating desired complete output wave form.

During idle period, the single chip reads out the data from its voltage dial plate and time dial plate. A timer is set according to the value set by the time dial plate to control widths T₁ and T₂ of the pulse output. The output voltage Ua of the converter DAC1 inset according to the value of the voltage dial plate such that the voltage of the energy storage capacitor C30 is adjusted. At the same time, a group of output data of the converter DAC0 is also calculated so that this converter will output the voltage wave form like that shown in FIG. 1. This group of data is corresponding to the voltage value set by the user and changes with set value. The group of output data of the converter DAC0 is calculated based on the following expressions (1) and (2).

$$\begin{matrix}Dn = \frac{Un}{{U}_{0}} \times {2}^{12} & ( 1 ) \\ \begin{matrix}Un = tg θ \times {t}_{n} \\ = tg θ \times n \times T \\ = tg θ \times n \times \frac{1}{f}\end{matrix} & ( 2 )\end{matrix}$$

In expression (1), Dn represents the n^{th} digital to analog conversion data to be output by the converter DAC0, U0 represents full scale voltage of the converter DAC0, while 2¹² represents the data of the full scale output. In expression (2), θ denotes voltage rising angle ∠θ₁ or falling angle ∠θ₂, while T is update period of the converter DAC0. Both parameters of θ and T are predetermined by the procedure and can be regulated conveniently, as shown in FIG. 6.

During idle period, the voltage output by the converter DAC0 is zero. When triggering condition is met, negative jump happens at the pin 62 of the single chip, thus resulting in interruption. The single chip outputs a value in every period T from zero V to U1, U2 and U3. Ramp voltage with small slope is output at the output pin (pin 100) of the converter DAC0. This ramp voltage is processed by the voltage follower and then is filtered by the capacitor C32 and finally imposed on node A. When the ramp voltage is increased to V₁, the converter DAC0 will keep the voltage constant and start the timer to count time. When time comes to T₁, the converter DAC0 will output (n+1)^{th} conversion data so that the output voltage will rise to V₂, and keep the current voltage constant for a period of time T₂. When time comes to T₂, the converter DAC0 will output a value in every period of time T. The output value will become smaller and smaller and fall with the angle of ∠θ₂, and finally become zero, thus completing an output cycle. Therefore, a voltage wave form as shown in FIG. 5 is generated at node A. Meanwhile, a wave form with amplitude consistent with the predefined value and shape same as that of FIG. 5 is output at the output end.

Conclusion can be drawn that the rising and falling of the voltage wave form will become smooth throughout the entire output process as long as the update period T of the converter DAC0 is sufficiently small (for example 10 microseconds). Moreover, parameters of the wave form such as ∠θ₁, ∠θ₂, V₁, T₁, V₂ and T₂ are completely determined by the procedure, thus making it easy to regulate the rising or falling angle, amplitude and width of the pulse.

FIG. 4 illustrates a ramp wave generated by charging capacitors with current-constant source. The step wave is formed by switching potential. It is clear that the voltage wave form of FIG. 1 will be defined easily with assistance of the procedure control. Rising slope of the ramp wave is determined coordinately by a capacitor C12 and a resistor R108. The amplitude proportion of the step wave is determined by resistors R95 and R107, while the width proportion and pulse width of the step wave are controlled by the procedure. In FIG. 4, Q7, Q8, Q9 and R108 cooperatively define a transistor mirroring current constant source (briefly denoted as current constant source), and capacitor C12 is the load of the current constant source.

The voltage applied on the capacitor can be expressed with the following formula.

$$\begin{matrix}{U}_{c ( t )} = {\int }_{- ∞}^{t} {i}_{c ( t )} {d}_{( t )} \\ = {\int }_{- ∞}^{0} {i}_{c ( t )} {d}_{( t )} + {\int }_{0}^{t} {i}_{c ( t )} {d}_{( t )} ,\end{matrix}$$

wherein i_{c(t)} represents constant current. As such; the following formula is obtained.

$$\begin{matrix}{u}_{c ( t )} = {\int }_{- ∞}^{0} I {d}_{( t )} + {\int }_{0}^{t} I {d}_{( t )} \\ = It {{\vert}_{- ∞}^{0} + It \vert}_{0}^{t} .\end{matrix}$$

Suppose that u_{c(t)}=0 when t=0. Then, u_{c(t)}=It. Apparently, the voltage u_{c(t)} imposed on the capacitor C12 is linearly proportional to time t. when I is larger than zero, u_{c(t)} will increase with the increase of time t, thus defining a ramp wave with the slope of k=tgθ=I. As a result, by changing the magnitude of the current constant source I, the rising slope of u_{c(t)} will also be changed. In other words, the rising angle θ of the wave form will also be changed. As such, the relationship curve between u_{c(t)} and t will be that as shown in FIG. 7 when the capacitor is charged with the current constant source I.

The generation process of the above wave form is described below.

When in idle period, the single chip waits for trigger signal. Under this condition, CON1=0, Q4 is turned off, CON3=1, Q5 is turned off, CON2=0, Q6 is turned on, the voltage of the capacitor C12 is pulled to zero, and therefore Ub is zero. Resultantly, the voltage output of the voltage follower constructed of U7-C is also zero.

The charging circuit adjusts the voltage of energy storage capacitor C30 based on preset voltage value Ua in order that C30 will have sufficient energy to be output, thus defining desired output wave form.

When trigger condition is met, negative jump will happen at the pin 12 of the single chip, resulting in interruption and immediate output of welding wave form. Under control of the single chip, CON2=1, Q6 is turned off CON3=1, Q5 is turned off, CON1=1, voltage Ub of the inverting input end of the voltage comparator U7-B is zero, while the voltage V₁ of non-inverting input end thereof is larger than zero. In this case, the voltage comparator will output high voltage and accordingly, Q4 is turned on such that the current constant source works. The current constant source charges the capacitor C12 with the constant current I, thereby causing linear increase of the voltage of C12 from zero. The voltage Ub of node A equal to that applied to the C12 is also increasing linearly, whereby forming a rising voltage wave form having a slope of I.

When Ub rises to V₁, CON1=1, CON2=1 and CON3=1 all of which are kept constant. The two voltages of the comparator U7-B are equal to each other. In this case, the output of the comparator together with Ud becomes low level. Q4 is turned off, and a direct current source stops working, and the voltage of C12 stops increasing. At the same time, as the voltage Ud is changed from high to low, interruption happens on the pin 13 of the single chip, thus triggering the single chip to count time and comparing the counted time with predefined time value T₁. At this time, the voltage comparator U7-B functions to keep Ub consistent with Ue (namely, V₁), thus generating wave form of V₁.

When it is determined by the single chip that counted time comes to predefined time T₁, the voltage V₁ of node A has maintained for a time of T₁. In this case, CON1=1 and CON2=1 all of which are kept unchanged. CON3 is immediately set to zero, Q5 is saturated and turned on. Voltage of Ua is increased to Ub. Voltage of node A rapidly jumps from V₁ to V₂. The single chip continues counting and compares the counted time with the predefined time T₂.

When it is determined by the single chip that counted time comes to predefined time T₂, the voltage Ua of node A has maintained for a time of T₂. In this case, CON1=0 and CON2=0. CON3 is immediately set to 1, Q4 and Q5 are turned off, while Q6 is tuned on. By the process contrary to that of angle rising, the current coming across Q6 is controlled by an additional circuit so that the current will be maintained constant. After that, the voltage Ub is decreased at an angle of ∠θ₁ to DV.

Accordingly, a complete step wave form is formed on node A, as shown in FIG. 5. By now, a complete pulse output cycle ends, and the welding machine again is in idle period, and waits for the next trigger signal.

According to circuit diagrams of the present embodiment, the generation of the step wave is done by applying additional voltage wave form on node A of the circuit diagram of FIG. 2. Accordingly, a switch may be installed on node A so as to switch the spot welding machine of the invention between using initial square wave and using the step wave of the invention.

The power supply controller provides desired step wave pulse for directly making the enameled wire welded. This is done under the principle of directly welding enameled wire. Pulse of step wave greatly reduces impact of the overlarge current on two electrode tip portions during period of burning off the insulating varnish. Advantageously, large amount of current flows into the work-piece during the welding period, hence current of welding period has no great impact on the tip portions. Pulse output of step wave suggested by the invention significantly extends lifespan of the welding head for directly welding enameled wires. For example, experiments are made in which enameled wires are welded using welding machine as disclosed in Chinese Patent Application No. CN01004785.7, welding head as disclosed in Chinese Patent Application No. CN01114708.8 and resistance welding head as disclosed in Chinese Patent Application No. CN200512159.2. When step wave voltage form is used, the lifespan of these welding heads are extended significantly, compared to cases when conventional square wave form is used.

It is noted of course, that the circuits described and illustrated in the specification are only illustrative and are not intended to limit the invention to what is disclosed. Rather, other circuits may be employed to obtain the step wave.

What is claimed is:

1. A micro-welding machine comprising a main power supply, a welding head and a headstock, wherein the main power supply comprises a resistance welding transformer and a power supply controller; the main power supply outputs step-wave pulse through the power supply controller during welding process and, during welding process, the headstock connects an output portion of the resistance welding transformer to the welding head.

2. The micro-welding machine as described in claim 1, wherein the power supply controller comprises a control circuit for generating pulse output, at least a function key for providing signal to the control circuit so as to regulate the pulse output, and a display device electronically connected with the control circuit so as to output information.

3. The micro-welding machine as described in claim 2, wherein the step wave generated by the power supply controller is formed by ∠θ₁, ∠θ₂, a first step (V₁, T₁), and a second step (V₂, T₂); the pulse output rises to the first step V₁ at an angle ∠θ₁ and is maintained for a time; afterwards, the pulse output rises further to the second step V₂ and is maintained for a time; then, the pulse output falls at an angle of ∠θ₂ until the end of the pulse output.

4. The micro-welding machine as described in claim 1, wherein the parameters constituting the step wave such as V₁, T, V₂ and T₂ may be adjusted.

5. The micro-welding machine as described in claim 4, wherein the power supply controller has at least a function key for regulating voltage (V₁) of the first step.

6. The micro-welding machine as described in claim 4, wherein the power supply controller has at least a function key for regulating duration (T₁) of the first step.

7. The micro-welding machine as described in claim 4, wherein the power supply controller has at least a function key for regulating voltage (V₂) of the second step.

8. The micro-welding machine as described in claim 4, wherein the power supply controller has at least a function key for regulating duration (T₂) of the second step.

9. The micro-welding machine as described in claim 3, wherein the power supply controller has at least a function key for regulating rising angle (∠θ₁) of the pulse output.

10. The micro-welding machine as described in claim 3, wherein the power supply controller has at least a function key for regulating falling angle (∠θ₂) of the pulse output.

11. The micro-welding machine as described in claim 1, wherein the welding machine is of a capacitor energy storage type or an invertible power type.

12. The micro-welding machine as described in claim 1, wherein the headstock is a headstock of the spot welding machine and capable of indicating pressure.

13. The micro-welding machine as described in claim 1, wherein the welding head is a spot welding head, a resistance welding head or a pair of parallel electrodes, or a pair of upper and lower electrodes.

14. The micro-welding machine as described in claim 1, wherein the step-wave pulse output provided by the control circuit of the power supply controller may be generated through a digital circuit such as ADC, or by charging a capacitor with a current-constant source and then switching the potentials.
